(19) United States
(12) Patent Application Publication
(10) Pub. No.: US 2023/0331131 A1
(43) Pub. Date: Oct. 19, 2023

(54) CONTAINER AND CONTAINER RECEPTACLE

(71) Applicant: ROSWELL CANADA INC., Acheson (CA)

(72) Inventor: John F. RUNSKE, Rockledge, FL (US)

(21) Appl. No.: 18/134,240

(22) Filed: Apr. 13, 2023

Related U.S. Application Data
(60) Provisional application No. 63/330,893, filed on Apr. 14, 2022.

(51) Int. Cl. B60N 3/10; B65D 25/20

(52) U.S. Cl. CPC B60N 3/101; B65D 25/20

(57) ABSTRACT

An apparatus (100), including: a container (110) including a magnetically responsive element (112); and a container receptacle (120) including a first magnet (122) and a drainage conduit (124) and configured to receive the container therein. A magnetic force created between the first magnet and the magnetically responsive element is configured to retain the container in the container receptacle. The first magnet defines a perimeter (126i) configured to accommodate a presence of the drainage conduit.

### FIELD OF THE INVENTION

The invention relates to a container receptacle that retains a container therein.

### BACKGROUND OF THE INVENTION

A variety of container receptacles exist to retain containers therein. Such arrangements allow for secure retention of the container under dynamic conditions such as those experienced in vehicles. Example vehicles include marine vessels (e.g., boats), motor vehicles, and off-road/utility vehicles. However, there remains room in the art for improvement.

### BRIEF DESCRIPTION OF THE DRAWINGS

The invention is explained in the following description in view of the drawings that show:

FIG. 1 shows an example embodiment of a container and an example embodiment of an associated container receptacle.

FIG. 2 shows an alternate example embodiment of the container receptacle.

FIG. 3 shows example embodiment of the container and an example embodiment of the container receptacle in use on a marine vessel.

FIG. 4 shows an alternate example embodiment of the container and an alternate example embodiment of the container receptacle.

FIG. 5 shows an alternate example embodiment of the container.

### DETAILED DESCRIPTION OF THE INVENTION

The present inventor has created a unique and innovative container receptacle and associated container. The container receptacle, (e.g., a cup holder), is suitable for retaining a container (e.g., a cup) therein under dynamic conditions such as those experienced by a vessel/vehicle in motion. The retention may be achieved using, for example, magnetic force. The container receptacle is also suitable for use in an environment where water (e.g., rainwater, ocean/laker/river water etc.) may find its way to the cup holder. The container receptacle may drain any water received therein via a drainage conduit.

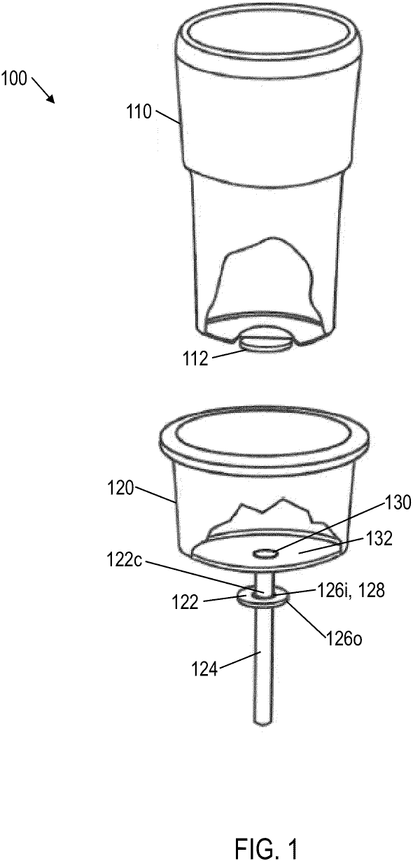

FIG. 1 shows a receptacle apparatus 100 that includes a container 110 and a container receptacle 120. The container 110 includes a magnetically responsive element 112 that may be a magnet or a material that is attracted by a magnet (e.g., a material containing iron). The container receptacle 120 includes a first magnet 122 and a drainage conduit 124 and is configured to receive the container 110 therein. A magnetic force (e.g., 8-10 pounds) created between the first magnet 122 and the magnetically responsive element 112 is configured to retain the container 110 in the container receptacle 120. The first magnet 122 defines at least one of an outer perimeter 126o and an inner perimeter 126i. At least one of the outer perimeter 126o and the inner perimeter 126i is configured to accommodate the drainage conduit 124.

As used herein, a meaning of configured to accommodate the drainage conduit 124 may include having a shape conforming at least in part to the drainage conduit 124, and/or including a feature (e.g., a hole) through which the drainage conduit 124 passes, and/or including a deviation from a symmetric shape to avoid abutting/interfering with the drainage conduit 124.

As shown in FIG. 1, the first magnet 122 is characterized by an annular (e.g., ring) shape. Other annular shapes are possible in which either or both the inner perimeter 126i and the outer perimeter 126o may deviate from having a circular shape. The inner perimeter 126i is configured to conform to the drainage conduit 124 by defining a hole 128 through the first magnet 122 through which the drainage conduit 124 passes. In this example embodiment, both the inner perimeter 126i and the outer perimeter 126o fully encircle the drainage conduit 124. In alternate example embodiments, either or both the inner perimeter 126i and the outer perimeter 126o may only partly encircle the drainage conduit 124.

In this example embodiment, a centroid 122c of the annular shape of the first magnet 122 is centered around the drainage conduit 124 at an inlet 130 to the drainage conduit 124 (e.g., centered in the container receptacle 120). In other example embodiments with annular shapes where either or both the inner perimeter 126i and the outer perimeter 126o deviate from having a circular shape, (e.g., a perimeter having an oval shape or any polygon shape), a centroid of the annular shape may (or may not be) be centered around the drainage conduit 124 at the inlet 130 (e.g., centered in the container receptacle 120).

The inlet 130 is disposed through a bottom wall 132 of the container receptacle 120 and is centered in the bottom wall 132 in this example embodiment. The bottom wall may be slightly concave and act as a funnel with having a low point that coincides with the inlet 130 to the drainage conduit 124. Any water/fluid that enters the container receptacle 120 will be urged under the influence of gravity toward and into the inlet 130 and then away via the drainage conduit 124.

The magnetically responsive element 112 of the container 110 is secured on or in the container 110 so that when the container 110 is positioned in the container receptacle 120, the magnetically responsive element 112 is drawn toward the first magnet 122 via a magnetic force. If the magnetically responsive element 112 is not a magnet, then the magnetic force originates with the first magnet 122 and draws the magnetically responsive element 112 toward the first magnet 122. If the magnetically responsive element 112 is a properly positioned magnet, then the magnetic force results from a mutual attraction between the first magnet 122 and the magnetically responsive element 112.

In the example embodiment of FIG. 1, the container receptacle 120 is configured to position the magnetically responsive element 112 directly over the first magnet 122. This may maximize the magnetic force therebetween. However, this is not necessary. The magnetically responsive element 112 may be positioned above but laterally offset from the first magnet 122 if preferred. Any relative positions are possible as long as a desired magnetic force is generated.

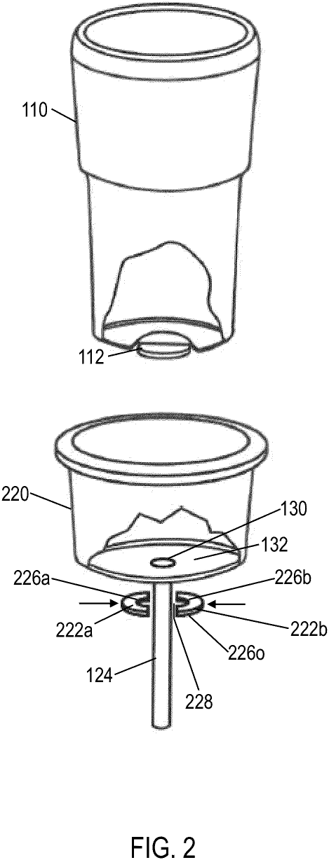

FIG. 2 shows an alternate example embodiment of the container receptacle 220. In this example embodiment, a first magnet 222a and a second magnet 222b are each semicircular in shape and together form an annular shape around the drainage conduit 124 and thereby define a hole 228 through which the drainage conduit 124 passes.

The first magnet 222a and the second magnet 222b may abut each other when moved in the directions of the arrows to form a continuous/uninterrupted annular shape (e.g., no gaps between the magnets). Alternately, the first magnet 222a and the second magnet 222b may be separated by a gap like that shown in FIG. 2 and thereby form a non-continuous/interrupted annular shape. Perimeters of the first magnet 222a and the second magnet 222b include respective concavities 226a, 226b that each partly encircle the drainage conduit 124. There may be any number of magnets and the magnets may form any shape when assembled together. Assembled shapes include annular shapes, oval shapes, any polygon shape, and random shapes that encircle part or all of the drainage conduit 124.

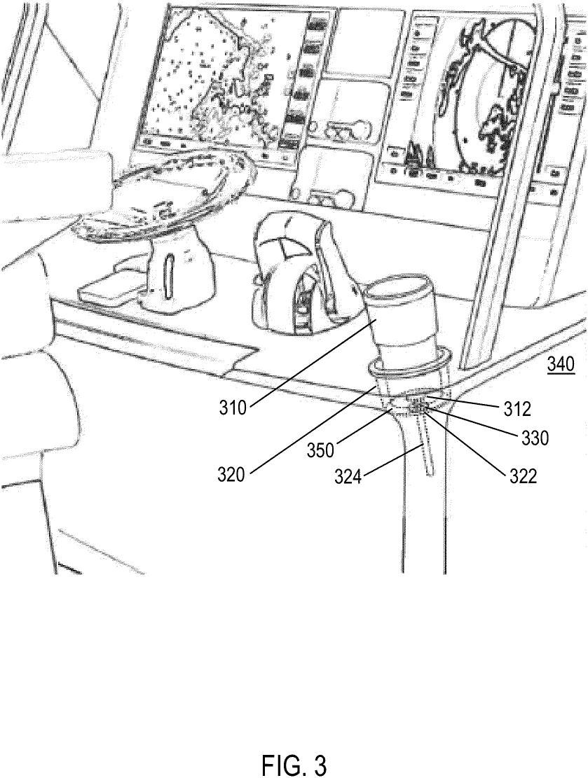

FIG. 3 shows example embodiment of the container 310 and an example embodiment of the container receptacle 320 in use in a center console 340 of a marine vessel. The magnetic force between the magnetically responsive element 312 and the first magnet 322 help retain the container 310 in the container receptacle 320 during the dynamic conditions experienced while operating the marine vessel. The drainage conduit 324 will drain water in the container receptacle 320. However, due to the angle of the container receptacle 320, the inlet 330 of the drainage conduit 324 may be disposed slightly above a lowest internal point 350 in the container receptacle 320.

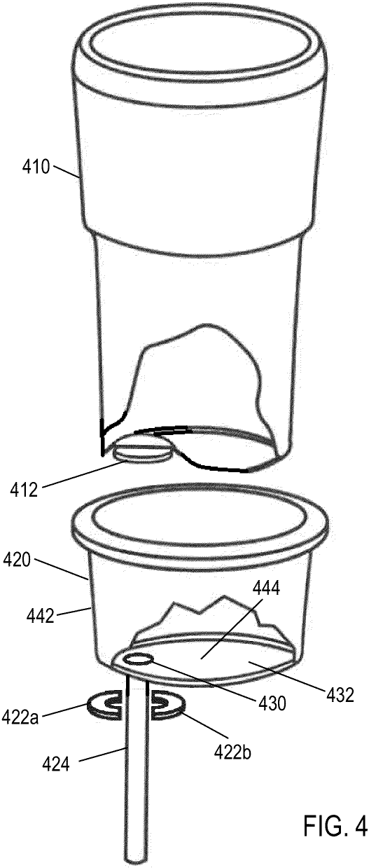

FIG. 4 shows an alternate example embodiment of the container 410 and an alternate example embodiment of the container receptacle 420. In this example embodiment, the inlet 430 to the drainage conduit 424 is not centered in the bottom wall 432. Instead, the inlet 430 is offset and disposed closer to a side wall 442 of the container receptacle 420 than to a center 444 of the bottom wall 432. Likewise, the magnetically responsive element 412 is laterally offset so that the magnetically responsive element 412 will be positioned directly above the first magnet 422a and the second magnet 422b when the container 410 is disposed in the container receptacle 420. This configuration puts the inlet 430 closer to or at the lowest point 350 when the container receptacle is installed at an angle as is shown in FIG. 3, which provides improved drainage.

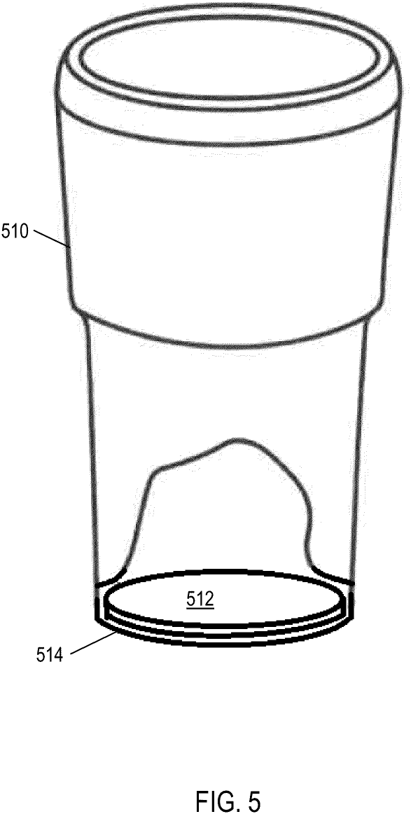

FIG. 5 shows an alternate example embodiment of the container 510 and an alternate example embodiment of the magnetically responsive element 512. In this example embodiment, the magnetically responsive element 512 is nearly as large as a bottom 514 of the container 510. A relatively large magnetically responsive element 512 will always establish a magnetic force between the first magnet in the container receptacle and the magnetically responsive element 512, regardless of whether the first magnet is centered (e.g., FIG. 1) or laterally offset (e.g., FIG. 4). This may simplify establishing the magnetic force when compared to, for example, the container 410 of FIG. 4 where the magnetically responsive element 412 must be aligned with the first magnet 422a and the second magnet 422b to maximize the magnetic force therebetween.

As has been disclosed above, the inventor has created a simple and effective container receptacle that retains a receptacle therein during dynamic conditions while providing adequate drainage. Consequently, this represents an improvement in the art.

While various embodiments of the present invention have been shown and described herein, it will be obvious that such embodiments are provided by way of example only. Numerous variations, swapping of features among embodiments, changes, and substitutions may be made without departing from the invention herein. Accordingly, it is intended that the invention be limited only by the spirit and scope of the appended claims.

The invention claimed is:

1. An apparatus, comprising:
a container comprising a magnetically responsive element; and
a container receptacle comprising a first magnet and a drainage conduit and configured to receive the container therein;
wherein a magnetic force created between the first magnet and the magnetically responsive element is configured to retain the container in the container receptacle; and
wherein the first magnet defines a perimeter configured to accommodate a presence of the drainage conduit.

2. The apparatus of claim 1, wherein the perimeter is configured to conform to the drainage conduit.

3. The apparatus of claim 1, wherein the perimeter of the first magnet at least partly encircles the drainage conduit.

4. The apparatus of claim 1, wherein an inner perimeter of the first magnet defines a hole through the first magnet through which the drainage conduit passes.

5. The apparatus of claim 4, wherein the first magnet comprises an annular shape.

6. The apparatus of claim 5, wherein a centroid of the annular shape is concentric with the drainage conduit.

7. The apparatus of claim 1, further comprising a second magnet, wherein when assembled together the first magnet and the second magnet together form a shape comprising an inner perimeter that defines a hole through which the drainage conduit passes.

8. The apparatus of claim 1, wherein the container receptacle is configured to position the magnetically responsive element directly over the first magnet.

9. The apparatus of claim 1, wherein the first magnet and an inlet to the drainage conduit are centered in the container receptacle, and the container receptacle is configured to center the magnetically responsive element directly over the first magnet.

10. The apparatus of claim 1, wherein the magnetically responsive element comprises a magnet.

11. The apparatus of claim 1, wherein an inlet to the drainage conduit is not centered in the container receptacle.

12. An apparatus, comprising:
a container comprising a magnetically responsive element; and
a container receptacle comprising a first magnet and a drainage conduit and configured to receive the container therein;
wherein the first magnet at least partly surrounds the drainage conduit.

13. The apparatus of claim 12, wherein the first magnet comprises a concavity configured to at least partly receive the drainage conduit therein.

14. The apparatus of claim 12, wherein the first magnet comprises a hole therethrough and the drainage conduit passes through the hole.

15. The apparatus of claim 14, wherein the first magnet comprises a ring shape that defines the hole.

16. The apparatus of claim 12, further comprising at least one additional magnet, wherein the first magnet and the at least one additional magnet together at least partly encircle the drainage conduit.

17. The apparatus of claim 16, wherein the first magnet and the at least one additional magnet together fully encircle the drainage conduit.

18. The apparatus of claim 17, wherein the first magnet and the at least one additional magnet together form an annular shape that fully encircles the drainage conduit.

19. The apparatus of claim 12 wherein a magnetic force created between the first magnet and the magnetically responsive element is configured to retain the container in the container receptacle.

20. The apparatus of claim 12, wherein the magnetically responsive element comprises a magnet.

21. The apparatus of claim 12, wherein an inlet to the drainage conduit is disposed closer to a side wall of the container receptacle than to a center of the container receptacle.
